(19) United States
(12) Patent Application Publication
(10) Pub. No.: US 2012/0163135 A1
(43) Pub. Date: Jun. 28, 2012

(54) TIMEPIECE FACEPLATE, AND TIMEPIECE

(75) Inventor: Koki TAKASAWA, Suwa (JP)

(73) Assignee: SEIKO EPSON CORPORATION, Tokyo (JP)

(21) Appl. No.: 13/330,912

(22) Filed: Dec. 20, 2011

(30) Foreign Application Priority Data
Dec. 27, 2010 (JP) 2010-291296
Mar. 24, 2011 (JP) 2011-066242

(51) Int. Cl. G04B 19/06

(52) U.S. Cl. 368/232

(57) ABSTRACT

To provide a timepiece faceplate that presents a rich stereoscopic effect, and to provide a timepiece comprising the timepiece faceplate, a timepiece faceplate 1 of the invention includes a microlens layer 11 in which a plurality of microlenses 111 are arranged in an orderly fashion as viewed from above; and a decorative layer 12 provided with a repeating design 121 having the same arrangement as the microlenses 111 and a pitch that differs from that of the microlenses 111. The microlens layer 11 and the decorative layer 12 are superimposed when the timepiece faceplate 1 is viewed from above. In a case that the centers of microlenses 111 that are adjacent when the faceplate 1 is viewed from above are connected by a straight line, the timepiece faceplate 1 has a plurality of triangles arranged in an orderly fashion in accordance with the straight line.

### CROSS-REFERENCE TO RELATED APPLICATIONS

This application claims priority to Japanese Patent Application Nos. 2010-291296 filed on Dec. 27, 2010 and 2011-066242, filed on Mar. 24, 2011. The entire disclosure of Japanese Patent Application Nos. 2010-291296 and 2011-066242 is hereby incorporated herein by reference.

### BACKGROUND

1. Technical Field

The present invention relates to a timepiece faceplate and a timepiece.

2. Background Technology

Timepieces and timepiece faceplates require functionality as a commercial product and decorative aspects (an aesthetic appearance) as a decorative ornament. Well-known faceplates for a timepiece are typically composed of a metal material in order to yield an appearance that imparts a sense of luxury. However, with a well-known timepiece faceplate, the range of the appearance that can be expressed is limited and it is not possible to sufficiently respond to consumer needs.

For example, there is considerable need for a timepiece provided with a faceplate that presents an appearance having a stereoscopic effect, and a timepiece faceplate has been proposed in which a plurality of designs and other patterns are formed and layered in alternating fashion with transparent films (see Patent Document 1).

However, with such a timepiece faceplate, a stereoscopic effect having a thickness equal to or greater than that of the timepiece faceplate cannot be expressed, and it is also difficult to significantly increase the thickness of the timepiece faceplate itself due to thickness limitations. Therefore, needs such as those described above cannot be sufficiently met. In the particular case of the faceplate applied to a portable timepiece such as a wristwatch, there is a considerable limitation to the thickness of the timepiece overall, and it is very difficult to achieve an appearance having a rich stereoscopic effect.

Japanese Patent Application Publication No. 2-306188 (Patent Citation 1) is examples of the related art.

### SUMMARY

### Problems to be Solved by the Invention

An advantage of the invention is to provide a timepiece faceplate that presents a rich stereoscopic effect, and to provide a timepiece provided with the timepiece faceplate.

### Means Used to Solve the Above-Mentioned Problems

The advantages described above are achieved by the invention described below. The timepiece faceplate of the invention is characterized in including: a microlens layer in which a plurality of microlenses are arranged in an orderly fashion as viewed from above; and a decorative layer provided with a repeating design having the same arrangement as the microlenses and a pitch that differs from that of the microlenses, wherein the microlens layer and the decorative layer are superimposed when viewed from above. It is thereby possible to provide a timepiece faceplate that presents an appearance having a rich stereoscopic effect

In the timepiece faceplate of the invention, preferably, in a case that centers of microlenses that are adjacent when the timepiece faceplate is viewed from above are connected by a straight line, a plurality of triangles are arranged in an orderly fashion in accordance with the straight line. It is thereby possible to impart a particularly excellent aesthetic appearance to a timepiece faceplate. In the timepiece faceplate of the invention, the triangles are preferably equilateral triangles. It is thereby possible to impart a particularly excellent aesthetic appearance to a timepiece faceplate.

In the timepiece faceplate of the invention, preferably, in a case that the centers of microlenses that are adjacent when the timepiece faceplate is viewed from above are connected by a straight line, a plurality of quadrangles are arranged in an orderly fashion in accordance with the straight line. It is thereby possible to impart a particularly excellent aesthetic appearance to a timepiece faceplate. In the timepiece faceplate of the invention, the quadrangles are preferably squares. It is thereby possible to impart a particularly excellent aesthetic appearance to a timepiece faceplate.

In the timepiece faceplate of the invention, the distance from a lens surface of the microlenses to a surface of the decorative layer is preferably 100 μm or more and 1000 μm or less. It is thereby possible to impart a richer stereographic effect to the appearance of a timepiece faceplate, and to impart a particularly excellent aesthetic appearance to a timepiece faceplate. In the timepiece faceplate of the invention, the focal distance of the microlenses is preferably 100 μm or more and 1000 μm or less. It is thereby possible to impart a particularly excellent aesthetic appearance to a timepiece faceplate.

In the timepiece faceplate of the invention, the pitch of the microlenses is preferably 50 μm or more and 500 μm or less. It is thereby possible to impart a particularly excellent aesthetic appearance to a timepiece faceplate. In the timepiece faceplate of the invention, the pitch of constituent units of the repeating design is 40 μm or more and 550 μm or less. It is thereby possible to impart a particularly excellent aesthetic appearance to a timepiece faceplate.

In the timepiece faceplate of the invention, the relationship 0.5≦L₁/L₀≦1.5 is preferably satisfied, where L₀ [μm] is the focal distance of the microlenses, and L₁ [μm] is the distance from the lens surface of the microlenses to the surface of the decorative layer. It is thereby possible to impart a richer stereographic effect to the appearance of a timepiece faceplate, and to impart a particularly excellent aesthetic appearance to a timepiece faceplate.

In the timepiece faceplate of the invention, the relationship 0.5≦P_{R}/P_{ML}≦1.5 is preferably satisfied, where P_{ML} [μm] is the pitch of the microlenses, and P_{R} [μm] is the pitch of the constituent units of the repeating design. It is thereby possible to impart a richer stereographic effect to the appearance of a timepiece faceplate, and to impart a particularly excellent aesthetic appearance to a timepiece faceplate.

In the timepiece faceplate of the invention, preferably, when the timepiece faceplate is viewed from above, the repeating design of the decorative layer and the microlenses of the microlens layer are provided to at least one part of a portion where time characters are not provided; and the repeating design of the decorative layer and/or the microlenses of the microlens layer are not provided to a portion in which the time characters are provided. It is thereby possible to impart a particularly excellent aesthetic appearance to a timepiece faceplate, and to achieve a higher level of both practicality as a commercial product and aesthetic appearance as a decoration, while the time visibility is made particularly excellent. The timepiece of the invention is characterized in being provided with the timepiece faceplate of the invention. It is thereby possible to provide a timepiece provided with a timepiece faceplate that presents an appearance having a rich stereoscopic effect.

### Effect of the Invention

In accordance with the invention, it is possible to provide a timepiece faceplate that presents an appearance having a rich stereoscopic effect, and to provide a timepiece provided with the timepiece faceplate.

### BRIEF DESCRIPTION OF THE DRAWINGS

Referring now to the attached drawings which form a part of this original disclosure:

FIG. 1 is a plan view showing a first embodiment of the timepiece faceplate of the invention;

FIG. 2 is a cross-sectional view of the timepiece faceplate shown in FIG. 1;

FIG. 3 is a plan view showing a second embodiment of the timepiece faceplate of the invention; and

FIG. 4 is a partial cross-sectional view of a preferred embodiment of the timepiece (portable timepiece) of the invention.

### DETAILED DESCRIPTION OF EXEMPLARY EMBODIMENTS

Preferred embodiments of the invention are described below with reference to the accompanying drawings. A preferred embodiment of the timepiece faceplate of the invention will be described first.

### Timepiece Faceplate

### First Embodiment

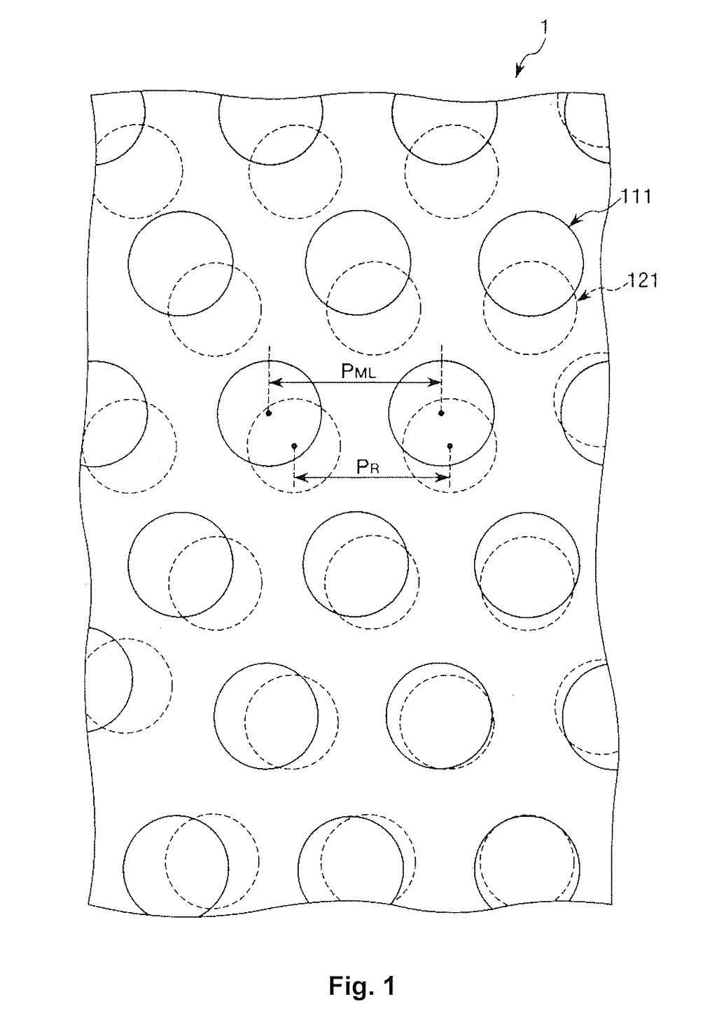

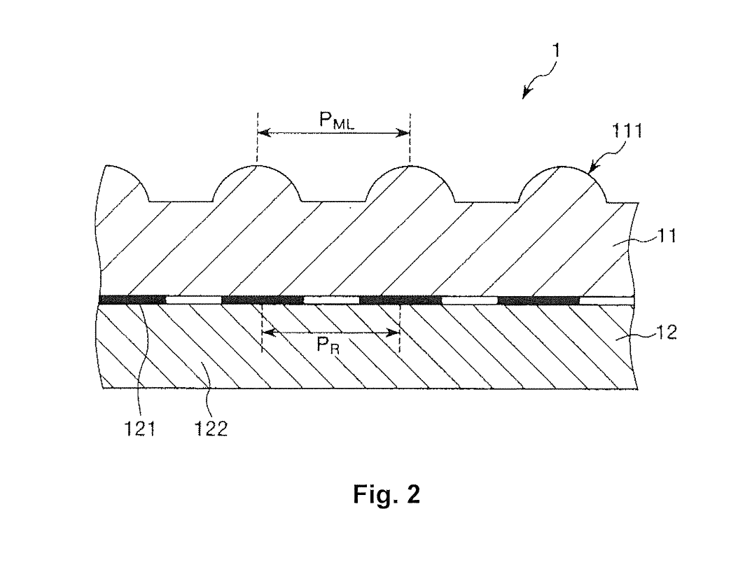

FIG. 1 is a plan view showing a first embodiment of the timepiece faceplate of the invention. FIG. 2 is a cross-sectional view of the timepiece faceplate shown in FIG. 1.

As shown, a timepiece faceplate 1 is provided with a microlens layer 11 and a decorative layer 12. The microlens layer 11 is provided with a plurality of microlenses 111, and the microlenses 111 are arranged in an orderly fashion when the timepiece faceplate 1 (microlens layer 11) is viewed from above. The decorative layer 12 has a repeating design 121 arranged in an orderly fashion when the timepiece faceplate 1 (decorative layer 12) is viewed from above. The repeating design 121 has the same arrangement as the microlenses 111, though the pitch thereof is different from that of the microlenses 111. The microlens layer 11 and the decorative layer 12 are in a superimposed configuration when the timepiece faceplate 1 is viewed from above.

As a result of thoroughgoing research, the present inventors found that by configuring the timepiece faceplate in this manner, it is possible to provide a timepiece faceplate that makes use of visual optical interference (moiré) and presents an appearance having a rich stereoscopic effect, and to provide a timepiece faceplate that can be discerned by an observer, through sensory misperception, to have a thickness that is equal to or greater than the real thickness of the timepiece faceplate. The timepiece faceplate 1 is used such that the microlens layer 11 is arranged further to the observer side (external surface side)

### Microlens Layer

The microlens layer 11 has a plurality of microlenses 111 arranged in an orderly fashion. In particular, in the present embodiment, a plurality of microlenses 111 is arranged so that, in a case that the centers of microlenses 111 that are adjacent when the timepiece faceplate 1 is viewed from above are connected by a straight line, a plurality of triangles are arranged in an orderly fashion in accordance with the straight line. It is thereby possible to impart a particularly excellent aesthetic appearance to a timepiece faceplate 1.

In the configuration shown in the drawings, the triangles are equilateral triangles. It is thereby possible to impart a particularly excellent aesthetic appearance to a timepiece faceplate 1. The focal distance of the microlenses 111 is preferably 100 μm or more and 1000 μm or less, and more preferably 150 μm or more and 500 μm or less. It is thereby possible to impart a particularly excellent aesthetic appearance to a timepiece faceplate 1.

The pitch P_{ML} of the microlenses 111 (when the timepiece faceplate 1 is viewed from above) is preferably 50 μm or more and 500 μm or less, and more preferably 60 μm or more and 300 μm or less. It is thereby possible to impart a particularly excellent aesthetic appearance to a timepiece faceplate 1. The microlens layer 11 is composed of a material having optical transmission properties. In the invention, the phrase “having optical transmission properties” refers to having a property in which at least a portion of light in the visible light region (380 to 780 nm) is transmitted; the transmissivity of light in the visible light region is preferably 50% or more; and the transmissivity of light in the visible light region is more preferably 60% or more. Such light transmissivity can be obtained by using, e.g., a white fluorescent light (FL20S-D65: a fluorescent light for examination manufactured by Toshiba Corp.) as the light source, and by using the ratio ((Y/X)×100 [%]), wherein X is the electric current value when power is generated at 1000 lux using only a solar cell (solar battery) having the same shape as the member to be measured (or the timepiece faceplate), and Y is the electric current value when power is generated in the same state except that the member to be measured (or the timepiece faceplate) is placed on the light source side of the solar cell. Unless otherwise stated in the present specification, the term “light transmissivity” refers to the value obtained under these conditions.

Examples of the material constituting the microlens layer 11 include various plastics materials and various glass materials, but the microlens layer 11 is preferably composed mainly of a plastic material. Plastic materials generally have excellent moldability (degree of freedom of molding), and can be advantageously used for manufacturing the timepiece faceplate 1 in various shapes. A microlens layer 11 composed of plastic material is advantageous for reducing the manufacturing cost of the timepiece faceplate 1. Plastic materials generally have excellent light (visible light) transmissivity, and also have excellent radio wave transmissivity. Therefore, when the microlens layer 11 is composed of a plastic material, the timepiece faceplate 1 can be advantageously applied to a solar timepiece (a timepiece provided with a solar battery) and a radio timepiece such as that described below. The focus of the description below is an example in which the plate-shaped member 11 is mainly composed of a plastic material. In the invention, the term “mainly” refers to a component present in the greatest amount content among the materials constituting the parts (members) under discussion. The content is not particularly limited, but is preferably 60 wt % or more, more preferably 80 wt % or more, and even more preferably 90 wt % or more of the material constituting the part (member) under discussion.

The plastic material constituting the microlens layer 11 may be any of a variety of thermoplastic resins, thermosetting resins, or the like. Suitable examples thereof include polycarbonate (PC), acrylonitrile-butadiene-styrene copolymer (ABS resin), polymethyl methacrylate (PMMA), and other acrylic resins; polyethylene (PE), polypropylene (PP), and other polyolefin resins; polyethylene terephthalate (PET) and other polyester resins; epoxy resins; urethane resins; and copolymers, blends, polymer alloys, or the like composed mainly of these. Also, one or more of these may be used in combination (e.g., blend resins, polymer alloys, laminates, and the like). It is particularly preferred that the microlens layer 11 be mainly composed of polycarbonate. The microlenses 111 can thereby be endowed with greater transparency, the refractive index of the microlenses 111 can be made optimal, and a particularly excellent aesthetic appearance can thereby be imparted to a timepiece faceplate 1 overall. A timepiece faceplate 1 having particularly excellent reliability can be obtained because the strength of the timepiece faceplate 1 overall can thereby be made particularly excellent, microlenses 111 having greater dimensional precession can be obtained, and unwanted deformations of the microlenses 111 or other anomalies can be more reliably prevented. In the case that the microlens layer 11 is composed of an acrylic resin, a polyester resin, an epoxy resin, or a urethane resin, the microlenses 111 can be more advantageously formed by a printing method (in particular, a droplet discharge method such as an inkjet method).

The microlens layer 11 may include components other than plastic material. Examples of such components include plasticizers, antioxidants, colorants (including various color formers, fluorescent substances, phosphorescent substances, and the like), brighteners, and fillers. For example, when the microlens layer 11 is composed of a material that includes a colorant, color variations of the timepiece faceplate 1 can be increased.

The microlens layer 11 may have an essentially uniform composition in each part, or may have a different composition depending on the part. The refractive index (absolute refractive index) of the microlens layer 11 is preferably 1.500 or more and 1.650 or less, and more preferably 1.550 or more and 1.600 or less. It is thereby possible to impart a particularly excellent aesthetic appearance to a timepiece faceplate 1.

In the configuration shown in the drawings, the microlenses 111 are substantially spherical in shape, and are spherical lenses that form a circular shape when viewed from above, but the shape of the microlenses 111 is not particularly limited. For example, it is possible to use a shape that is barrel-shaped (substantially oval shape, elliptical shape), substantially triangular, substantially quadrangular, substantially hexagonal, or the like when viewed from above. The shape and size of the microlens substrate (microlens layer) 11 is not particularly limited and is ordinarily determined based on the shape and size of the timepiece faceplate 1 to be manufactured. In the configuration shown in the drawings, the microlens substrate 11 is a flat plate shape, but may also be, e.g., a curved plate shape, or the like.

The microlens substrate 11 may be molded using any method; examples of methods for molding the microlens substrate 11 include compression molding, extrusion molding, injection molding, photo fabrication, and the 2P method. The microlens substrate 11 may be, e.g., a plate-shaped member that does not have microlenses 111, whereon a liquid material containing the constituent material of the microlenses 111 is discharged by the inkjet method or another liquid discharge method to thereby form the microlenses 111. The microlenses 111 may be formed using offset printing, gravure printing, or various other types of printing methods. Microlenses formed using a printing method are advantageous in that the production costs of the microlens substrate 11 can be reduced. In the invention, the shape of at least a portion of the microlenses of the microlens substrate is not required to be circular when viewed from above and may be, e.g., ovoid. The plurality of microlenses may be independently arranged or adjacently connected.

### Decorative Layer

The decorative layer 12 has a repeating design 121 arranged in an orderly fashion when the timepiece faceplate 1 (decorative layer 12) is viewed from above. In the particular case of the timepiece faceplate 1 of the present embodiment, the decorative layer (decorative plate) 12 has a configuration in which the repeating design 121 is provided on the substrate 122. The repeating design 121 can thereby be more reliably secured, and as a result, the timepiece faceplate 1 can reliably demonstrate an aesthetic appearance over a long period of time. In other words, a timepiece faceplate 1 having particularly excellent reliability can be obtained.

The repeating design 121 has the same arrangement as the microlenses 111, and is provided at a pitch that differs from that of the microlenses 111. The pitch P_{R} of the constituent units of the repeating design 121 (the pitch when the timepiece faceplate 1 is viewed from above) is preferably 40 μm or more and 550 μm or less, and more preferably 50 μm or more and 350 μm or less. It is thereby possible to impart a particularly excellent aesthetic appearance to a timepiece faceplate 1.

The pitch P_{ML} [μm] of the microlenses and the pitch P_{R} [μm] of the constituent units of the repeating design 121 preferably satisfy the relationship 0.5≦P_{R}/P_{ML}≦1.5, and more preferably satisfy the relationship 0.7≦P_{R}/P_{ML}≦1.3. It is thereby possible to provide the appearance of a timepiece faceplate with a richer stereoscopic effect and to impart a particularly excellent aesthetic appearance to a timepiece faceplate 1. In the case that the pitch of the repeating design 121 is less than the pitch of the microlenses 111, the design will appear to be recessed, and when the pitch of the repeating design 121 is greater than the pitch of the microlenses 111, the design will appear to be floating. The constituent units of the repeating design 121 form a circular shape in the configuration shown in the drawings, but any shape may be used, examples of which include polygonal shapes, oval shapes, star shapes, alphabet letters and other characters, and cartoon characters and other more complex shapes.

The repeating design 121 may be composed of any material, examples of which include various pigments, various dyes, and other colorants; and materials containing a metal material. The repeating design 121 may be composed of a material containing a resin material. It is thereby possible to cause the repeating design 121 to have particularly exceptional adhesion to the substrate 122.

The repeating design 121 may be formed using any method, examples of which include screen printing, gravure printing, pad printing, inkjet method, and various other printing methods. Etching treatment is carried out on the film formed on the substrate 122, and the remaining portion may be used as the repeating design 121. The substrate 122 may be composed of any material as long as a function is provided for holding the repeating design 121, and is preferably composed of a plastic material in terms of the durability and ease of handling of the timepiece faceplate 1. When the substrate 122 is composed of a material having optical transmission properties, the timepiece faceplate 1 can be advantageously applied to a solar timepiece (a timepiece provide with a solar battery).

The plastic material constituting the substrate 122 may be any of a variety of thermoplastic resins, thermosetting resins, or the like. Suitable examples include polycarbonate (PC), acrylonitrile-butadiene-styrene copolymer (ABS resin), polymethyl methacrylate (PMMA), and other acrylic resins; polyethylene (PE), polypropylene (PP), and other polyolefin resins; polyethylene terephthalate (PET) and other polyester resins; and copolymers, blends, polymer alloys, or the like composed mainly of these. One or more of these may be used in combination (e.g., blend resins, polymer alloys, laminates, and the like). It is particularly preferred that the substrate 122 be mainly composed of polycarbonate. The strength of the timepiece faceplate 1 overall can thereby be made particularly excellent. A timepiece faceplate 1 having particularly excellent reliability can be obtained because deformation of the repeating design 121 or other unwanted anomalies can be more reliably prevented.

The substrate 122 may include components other than plastic material. Examples of such components include plasticizers, antioxidants, colorants (including various color formers, fluorescent substances, phosphorescent substances, and the like), brighteners, and fillers. For example, when the substrate 122 is composed of a material that includes a colorant, color variations of the timepiece faceplate 1 can be increased. The substrate 122 may have an essentially uniform composition in each part, or may have a different composition depending on the part.

The distance from the lens surface of the microlenses 111 (the upper-side surface in FIG. 2) to the surface of the later-described decorative layer 12 (upper-side surface in FIG. 2) is preferably 100 μm or more and 1000 μm or less, and more preferably 150 μm or more and 500 μm or less. It is thereby possible to provide the appearance of a timepiece faceplate 1 with a richer stereoscopic effect and to impart a particularly excellent aesthetic appearance to a timepiece faceplate 1.

In particular, in the present embodiment, a plurality of microlenses 111 is arranged so that, in a case that the centers of microlenses 111 that are adjacent when the timepiece faceplate is viewed from above are connected by a straight line, a plurality of triangles is arranged in an orderly fashion in accordance with the straight line. In such a case, the distance from the lens surface of the microlenses 111 (the upper-side surface in FIG. 2) to the surface of the decorative layer 12 (upper-side surface in FIG. 2; described below) is preferably 150 μm or more and 500 μm or less, and more preferably 150 μm or more and 300 μm or less. It is thereby possible to provide the appearance of a timepiece faceplate 1 with a richer stereoscopic effect and to impart a particularly excellent aesthetic appearance to a timepiece faceplate 1.

The focal distance L₀ [μm] of the microlenses 111 and the distance L₁ [μm] from the lens surface of the microlenses 111 to the surface of the decorative layer 12 preferably satisfy the relationship 0.5≦L₁/L₀≦1.5, and more preferably satisfy the relationship 0.6≦L₁/L₀≦1.4. It is thereby possible to provide the appearance of a timepiece faceplate with a richer stereoscopic effect and to impart a particularly excellent aesthetic appearance to a timepiece faceplate 1.

The shape and size of the decorative plate (decorative layer) 12 is not particularly limited, and is ordinarily determined based on the shape and size of the timepiece faceplate 1 to be manufactured. In the configuration shown in the drawings, the decorative layer 12 is a flat plate shape, but may also be, e.g., a curved plate shape, or the like. The timepiece faceplate 1 preferably has the repeating design 121 and the microlenses 111 of the microlens layer provided to at least one part of the portion in which the time characters are not provided; and the repeating design 121 and/or the microlenses of the microlens layer 111 not provided to the portion in which the time characters are provided. It is thereby possible to impart a particularly excellent aesthetic appearance to a timepiece faceplate 1, and to achieve a higher level of both practicality as a commercial product and aesthetic appearance as a decoration, while time visibility is made particularly excellent.

In the configuration shown in the drawings, the microlens substrate (microlens substrate) 11 and the decorative layer (decorative plate) 12 are in close contact. The distance between the microlenses 111 and the repeating design 121 can thereby be kept constant, and the appearance of the timepiece faceplate 1 can be provided with excellent stability. The timepiece faceplate 1 is preferably applied to a portable timepiece (e.g., a wristwatch). Portable timepieces are timepieces having a particular requirement for thinness, and in accordance with the invention, the stereoscopic effect of the timepiece faceplate can be made sufficiently excellent while the timepiece faceplate is made sufficiently thin. In other words, the effects of the invention can be more dramatically demonstrated in the case that the timepiece faceplate of the invention is applied to a portable timepiece.

### Second Embodiment

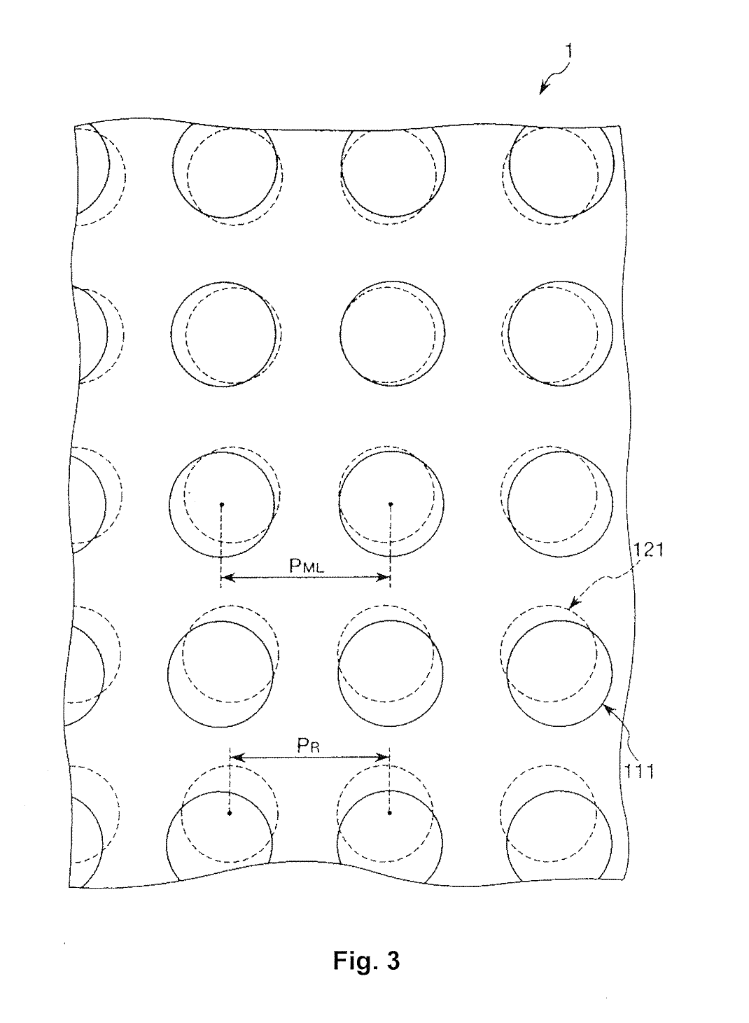

FIG. 3 is a plan view showing a second embodiment of the timepiece faceplate of the invention. The timepiece faceplate of a second embodiment is described below with respect to the points of difference from the first embodiment, and not to any points of similarity therewith. With the timepiece faceplate 1 of the present embodiment, in a case that the centers of microlenses 111 that are adjacent when the timepiece faceplate 1 is viewed from above are connected by a straight line, a plurality of quadrangles is arranged in an orderly fashion in accordance with the straight line. In correspondence therewith, in the case that the centers of repeating designs 121 that are adjacent when the timepiece faceplate 1 is viewed from above are connected by a straight line, an arrangement pattern of the repeating design 121 also has a plurality of quadrangles arranged in an orderly fashion in accordance with the straight line. Thus, in the invention, the arrangement pattern of the microlenses and the repeating design is not limited to that described in the first embodiment, and the same effect as that described above can be obtained when an arrangement pattern such as the present embodiment is used. When an arrangement pattern such as the present embodiment is used, is possible to impart a particularly excellent aesthetic appearance to the timepiece faceplate 1.

In the configuration shown in the drawings, the quadrangles are squares. It is thereby possible to impart a particularly excellent aesthetic appearance to a timepiece faceplate 1. In particular, a plurality of microlenses 111 are arranged so that, in a case that the centers of microlenses that are adjacent when the timepiece faceplate 1 is viewed from above are connected by a straight line, a plurality of quadrangles are arranged in an orderly fashion in accordance with the straight line, as in the present embodiment. In such a case, the distance from the lens surface of the microlenses 111 (the upper-side surface in FIG. 2) to the surface of the decorative layer 12 (upper-side surface in FIG. 2) is preferably 100 μm or more and 1000 μm or less, and more preferably 250 μm or more and 600 μm or less. It is thereby possible to provide the appearance of a timepiece faceplate 1 with a richer stereoscopic effect and to impart a particularly excellent aesthetic appearance to a timepiece faceplate 1.

### Timepiece

Described next is the timepiece of the invention provided with the timepiece faceplate of the invention described above. The timepiece of the invention has the timepiece faceplate of the invention described above. As described above, the timepiece faceplate of the invention presents an appearance with rich stereoscopic effect; is particularly capable of being discerned by an observer, through sensory misperception, to have a thickness that is equal to or greater than the real thickness of the timepiece faceplate; and has excellent decorative characteristics (an excellent aesthetic appearance). Excellent optical transmission properties can be imparted to the overall timepiece faceplate 1 while an excellent appearance such as that described above can be ensured by the selection of the materials of the decorative layer 12, the substrate 122, and the like. Accordingly, the timepiece of the invention provided with such a timepiece faceplate can sufficiently satisfy the requirements of a solar timepiece. It is possible to use known components other than the timepiece faceplate constituting the timepiece of the invention (the timepiece faceplate of the invention). An example of the configuration of the timepiece of the invention is described below.

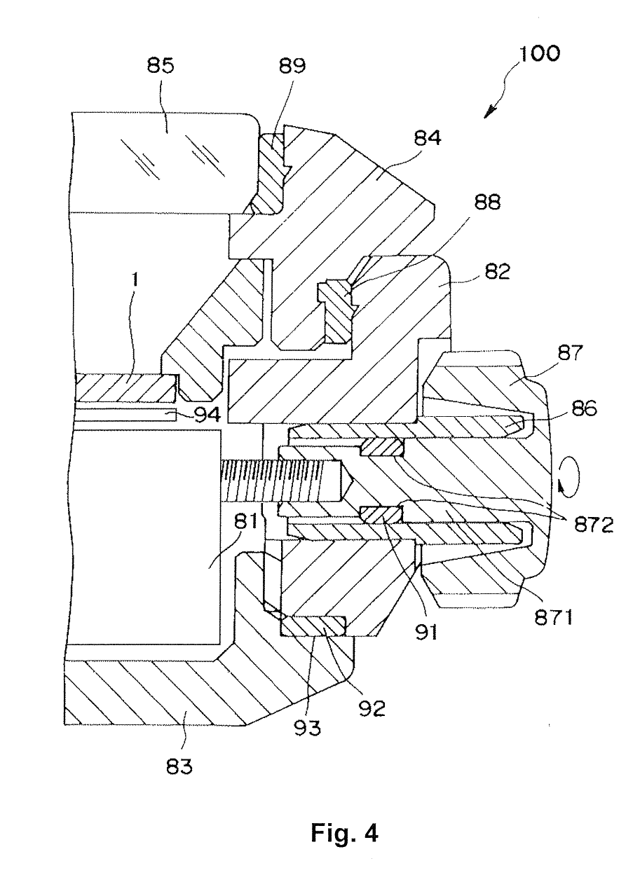

FIG. 4 is a cross-sectional view of a preferred embodiment of the timepiece (portable timepiece) of the invention. The wristwatch (portable timepiece) 100 of the present embodiment is provided with a case body (case) 82, a case back 83, a bezel (edge) 84, and a glass plate (cover glass) 85, as shown in FIG. 4. Also accommodated inside the case 82 are the timepiece faceplate 1 of the invention as described above, a solar battery 94, a movement 81, and hands (indicator; not shown) and the like. The timepiece faceplate 1 is provided between the solar battery 94 and the glass plate (cover glass) 85, and the microlens substrate 11 is arranged so as to face the glass plate (cover glass) 85 side.

The glass plate 85 is ordinarily composed of transparent glass, sapphire, or the like having high transparency. The aesthetic properties of the timepiece faceplate 1 of the invention can thereby be sufficiently demonstrated, and a sufficient amount of light can be allowed to be incident on the solar battery 94. The movement 81 drives the hands using the electromotive force of the solar battery 94. Although not shown in FIG. 4, there are provided inside the movement 81, e.g., an electric double layer capacitor for storing the electromotive force of the solar battery 94, a lithium-ion secondary battery, a crystal oscillator as a time reference source, a semiconductor integrated circuit for generating a drive pulse for driving the timepiece on the basis of the oscillating frequency of the crystal oscillator, a step motor for driving the hands in one-second increments on the basis of the drive pulse, a train wheel mechanism for transmitting the movement of the step motor to the hands, and other components.

The movement 81 is provided with an antenna (not shown) for receiving radio waves, and has a function for performing time adjustment or the like using the received radio waves. The solar battery 94 has a function for converting light energy into electric energy. The electric energy converted by the solar battery 94 is used for driving the movement and for other purposes. The solar battery 94 has, e.g., a p-i-n structure in which a p-type impurity and an n-type impurity are selectively introduced into non-single crystal silicon thin films, and an i-type non-single crystal silicon thin film having a low impurity concentration is provided between the p-type non-single crystal silicon thin film and the n-type non-single crystal silicon thin film.

A stem pipe 86 is fitted into and secured to the case 82, and a shaft part 871 of a crown 87 is rotatably inserted into the stem pipe 86. The case 82 and bezel 84 are secured by a plastic gasket 88, and the bezel 84 and glass plate 85 are secured by a plastic gasket 89. The case back 83 is fitted (or threaded) onto the case 82, and a ring-shaped rubber gasket (case back gasket) 92 is intermediately inserted in a compressed state into these joining parts (seal parts) 93. This configuration fluid-tightly seals the joining parts, and a waterproof function is obtained.

A groove 872 is formed in the outer periphery of the crown 87 at a midway point of the shaft part 871, and a ring-shaped rubber gasket (crown gasket) 91 is fitted into the groove 872. The rubber gasket 91 is in close contact with the internal peripheral surface of the stem pipe 86, and is compressed between the internal peripheral surface and the inner surface of the groove 872. This configuration fluid-tightly seals the crown 87 and the stem pipe 86, and a waterproof function is obtained. When the crown 87 is rotatably operated, the rubber gasket 91 rotates together with the shaft part 871, and slides in the peripheral direction while in close contact with the internal peripheral surface of the stem pipe 86. Among various types of timepieces, a watch (wristwatch) such as that described above particularly needs to be made thinner. Therefore, the invention can be more advantageously applied in that the timepiece faceplate is made thinner and an excellent aesthetic appearance is obtained.

In the description above, a wristwatch (portable timepiece) as a solar radio wave timepiece was described as an example of a timepiece, but the invention can also be similarly applied to portable timepieces other than a wristwatch, a fixed timepiece, a wall timepiece, and various other types of timepieces. The invention can also be applied to solar timepieces excluding solar radio wave timepieces, radio wave timepieces excluding solar radio wave timepieces, and any other timepiece. Preferred embodiments of the invention are described above, but the invention is not limited to the description above.

For example, with the timepiece faceplate and the timepiece of the invention, the configuration of each part can be substituted with any configuration that demonstrates the same function, and any configuration may be added. An example of such an addition is a printed part formed by various printing methods. In the embodiments described above, at least one layer may be provided to the surface of the microlens layer and/or the decorative layer. Such a layer may be removed when, e.g., the timepiece faceplate enters service or at another time.

In the embodiments described above, it is described as typical for the microlenses to be provided in the same pattern on the microlens layer, but the microlens layer may have a plurality of regions in which the arrangement pattern of the microlenses is different. Similarly, it is described as typical for the repeating design to be provided in the same pattern on the decorative layer, but the decorative layer may have a plurality of regions in which the arrangement pattern of the repeating design is different. The decorative layer may have a plurality of regions in which the shape of the constituent units of the repeating design is different. Also, the pitch, arrangement, and the like of adjacent microlenses may continuously vary. Similarly, the pitch, arrangement, and the like of constituent units of the repeating design may continuously vary.

In the description of the embodiments above, focus is placed on the case in which a repeating design and/or microlenses are not provided to the portion in which the time characters are provided, when the timepiece faceplate is viewed from above. However, the repeating design and the microlenses may be provided to the portion in which the time characters are provided. In the embodiments described above, it is described as typical for the microlens layer to be provided with convex lenses as the microlenses, but the microlenses may be concave lenses as long as the focal points are connected on the surface side on which the decorative layer is provided.

In the embodiments described above, the repeating design is described as being provided to the surface of the substrate, but the repeating design may be provided directly to the surface of the microlens layer. Described as being typical in the embodiments described above is the case in which the microlens layer provided with the microlenses and the decorative layer provided with the repeating design are in close contact, but the microlens layer and the decorative layer are not required to be in close contact.

### EXAMPLES

Described next are specific examples of the invention.

### 1. Manufacture of the Timepiece Faceplate

Faceplates for a timepiece (faceplates for a wristwatch) were manufactured as examples and comparative examples using a method such as the following.

### Example 1

First, a matrix having the shape of a faceplate for a wristwatch was fabricated by injection molding using polycarbonate (absolute refractive index: 1.586), required locations were then punched out, and unnecessary burrs and the like were cut off and polished away to obtain a microlens substrate on which a plurality of hemispherical microlenses was formed. The resulting microlens substrate was substantially discoid in shape, and had a diameter of 27 mm and an average thickness of 250 μm. Also, the resulting microlens substrate has microlenses provided across the entire first surface, which was one main surface (excluding, however, the locations in which the time characters were to be formed). The resulting microlens substrate had a plurality of equilateral triangles arranged in an orderly fashion in accordance with a line that connects the centers of adjacent microlenses when the microlens substrate is viewed from above (see FIG. 1). The focal distance of the microlenses was 250 μm. The pitch P_{ML} of the microlenses was 120 μm. The microlens substrate had a flat second surface, which was the main surface on the side opposite from the first surface, and the surface roughness Ra of the first surface was 0.07 μm.

Time characters and marks were affixed using an adhesive in regions in which the microlenses were not provided on the first surface of the microlens substrate. Next, a matrix having the shape of a faceplate for a wristwatch was fabricated by injection molding using polycarbonate, required locations were then punched out, and unnecessary burrs and the like were cut off and polished away to obtain a substrate with a flat-plate shape. The resulting substrate was substantially discoid in shape, and had a diameter of 27 μm and an average thickness of 250 μm. The resulting substrates were flat on both main surfaces, and the surface roughness Ra of the surfaces was 0.07 μm.

A repeating design in which numerous circular constituent units were arranged in an orderly fashion were formed by the inkjet method using ink containing acrylic resin and C.I. pigment red 254 as the pigment on the first surface, which is one of the main surfaces, of the substrate obtained in the manner described above to obtain a decorative layer. The repeating design thus formed had a plurality of equilateral triangles arranged in an orderly fashion in accordance with a line that connects the centers of adjacent constituent units (circles) when the substrate was viewed from above (see FIG. 1). The pitch P_{R} of the constituent units of the repeating design was 115 μm. However, the repeating design was not formed in the regions superimposed with the time characters when the ultimately obtained timepiece faceplate is viewed from above. The second surface of the microlens substrate and the first surface of the decorative layer were thereafter superimposed so as to be in contact with each other to thereby obtain a timepiece faceplate.

### Examples 2 to 13

Faceplates for a wristwatch were manufactured in the same manner as Example 1, except that the conditions of the microlens substrate and the decorative layer were as shown in Table 1.

### Comparative Example 1

A timepiece faceplate was manufactured in the same manner as Example 1, except that a microlens substrate was not manufactured and only a decorative plate was used in the configuration. Time characters and marks were affixed to the decorative layer in the same manner as when affixed to the microlens substrate in Example 1.

### Comparative Example 2

A timepiece faceplate was manufactured in the same manner as Example 1, except that a decorative plate was not manufactured and only a microlens substrate was used in the configuration.

### Comparative Example 3

A repeating design in which numerous circular constituent units were arranged in an orderly fashion were formed by the inkjet method using ink containing acrylic resin and C.I. pigment red 254 as the pigment on the second surface of the decorative layer. A timepiece faceplate was thereafter manufactured in the same manner as comparative example 1, except that the time character and marks were affixed to the first surface of the decorative layer in the same manner as performed on the microlens substrate in Example 1. The repeating design provided to the second surface of the decorative layer had a plurality of equilateral triangles arranged in an orderly fashion in accordance with a line that connects the centers of adjacent constituent units (circles) when the substrate was viewed from above, and the pitch of the constituent units of the repeating design was 110 μm.

### Comparative Example 4

A timepiece faceplate was manufactured in the same manner as Comparative example 3, except that the thickness of the substrate was changed to 500 μm.

### Comparative Example 5

First, a matrix having the shape of a faceplate for a wristwatch was fabricated by injection molding using polycarbonate, required locations were then punched out, and unnecessary burrs and the like were cut off and polished away to obtain a flat substrate. The resulting substrate was substantially discoid in shape, and had a diameter of 27 mm and an average thickness of 100 μm. A printed layer was formed using ink containing acrylic resin and C.I. pigment red 254 as the pigment on the entire first surface, which is a main surface of the substrate, obtained in the manner described above.

Next, an uncured acrylic resin was applied to the entire surface of a coating film, and then cured by heating to form a transparent coating film. The thickness of the transparent coating film was 50 μm. A repeating design in which numerous circular constituent units were arranged in an orderly fashion was thereafter formed by the inkjet method using ink containing acrylic resin and C.I. pigment red 254 as the pigment on the surface of the transparent coating film. The repeating design thus formed had a plurality of equilateral triangles arranged in an orderly fashion in accordance with a line that connects the centers of adjacent constituent units (circles) when the substrate was viewed from above. The pitch P_{R} of the constituent units of the repeating design was 110 μm. However, the repeating design was not formed in the regions superimposed with the time characters when the ultimately obtained timepiece faceplate is viewed from above.

The formation of the transparent coating film and repeating design was thereafter repeated in the same manner as described above, and the entire thickness was brought to 500 μm. At this point, two layers among the layered plurality of repeating design layers were arranged so as to be imperfectly superimposed when the substrate is viewed from above. Time characters and marks were then affixed to the layered body to obtain a timepiece faceplate.

The configuration of the timepiece faceplate of the examples and comparative examples are summarized in Table 1. In the table, L₀ [μm] is the focal distance of the microlenses, L₁ [μm] is the distance from the lens surface of the microlenses to the surface of the decorative layer, P_{ML} [μm] is the pitch of the microlenses, and P_{R} [μm] is the pitch of the constituent units of the repeating design. Also, in the table, PC refers to polycarbonate, PEs refers to polyester resin, and Ac refers to acrylic resin. In the column “Arrangement pattern” of the microlenses and the repeating design in Table 1, “a” indicates a pattern in which a plurality of triangles are arranged in an orderly fashion in accordance with a line that connects the centers of adjacent microlenses or constituent units of the repeating design when the timepiece faceplate is viewed from above, as shown in FIG. 1; and “b” indicates a pattern in which a plurality of quadrangles is arranged in an orderly fashion in accordance with a line that connects the centers of adjacent microlenses or constituent units of the repeating design when the timepiece faceplate is viewed from above, as shown in FIG. 3. Each location of the timepiece faceplate is composed of the component shown in Table 1 as the main component, and the content of other components was less than 0.1 wt %.

TABLE 1

| | Microlens substrate | | | | | | Decorative plate | | | | | |
|---|---|---|---|---|---|---|---|---|---|---|---|---|
| | | | | Microlens | | | Substrate | | Repeating design | | | |
| | | | Average | | Pitch | Focal | | Average | | Pitch | | |
| | Constituent | Refractive | thickness | Arrangement | P_{ML} | distance | Constituent | thickness | Arrangement | P_{R} | | |
| | material | index | (μm) | pattern | (μm) | L₀ (μm) | material | (μm) | pattern | (μm) | L₁/L₀ | P_{R}/P_{ML} |
| Example 1 | PC | 1.586 | 250 | a | 120 | 250 | PC | 250 | a | 115 | 1 | 0.96 |
| Example 2 | PC | 1.586 | 300 | a | 120 | 300 | PC | 200 | a | 110 | 1 | 0.92 |
| Example 3 | PC | 1.586 | 250 | a | 160 | 250 | PC | 250 | a | 150 | 1 | 0.94 |
| Example 4 | PC | 1.586 | 400 | b | 200 | 400 | PC | 100 | b | 190 | 1 | 0.95 |
| Example 5 | Ac | 1.49 | 250 | a | 120 | 250 | PC | 250 | a | 125 | 1 | 1.04 |
| Example 6 | PEs | 1.54 | 250 | a | 120 | 250 | PC | 250 | a | 115 | 1 | 0.96 |
| Example 7 | PC | 1.586 | 100 | a | 120 | 100 | PC | 400 | a | 110 | 1 | 0.92 |
| Example 8 | PC | 1.586 | 800 | b | 200 | 800 | PC | 100 | b | 210 | 1 | 1.05 |
| Example 9 | PC | 1.586 | 250 | a | 60 | 250 | PC | 300 | a | 70 | 1 | 1.17 |
| Example 10 | PC | 1.586 | 400 | b | 400 | 400 | PC | 200 | b | 410 | 1 | 1.03 |
| Example 11 | Ac | 1.49 | 400 | b | 350 | 400 | PC | 200 | b | 340 | 1 | 0.97 |
| Example 12 | PC | 1.586 | 100 | a | 50 | 100 | PC | 500 | a | 60 | 1 | 1.2 |
| Example 13 | PEs | 1.586 | 600 | b | 450 | 600 | PC | 300 | b | 440 | 1 | 0.98 |
| Comparative | — | — | — | — | — | — | PC | 250 | a | 115 | — | — |
| example 1 | | | | | | | | | | | | |
| Comparative | PC | 1.586 | 250 | a | 120 | 250 | — | — | — | — | — | — |
| example 2 | | | | | | | | | | | | |
| Comparative | — | — | — | — | — | — | PC | 250 | a | 115 | — | — |
| example 3 | | | | | | | | | | | | |
| Comparative | — | — | — | — | — | — | PC | 500 | a | 115 | — | — |
| example 4 | | | | | | | | | (both | | | |
| | | | | | | | | | surfaces) | | | |
| Comparative | — | — | — | — | — | — | PC | 100 | a | 110 | — | — |
| example 5 | | | | | | | | | (multi- | | | |
| | | | | | | | | | layering) | | | |

### 2. Evaluation of the Appearance of a Faceplate for a Wristwatch (Evaluation of Stereoscopic Effect)

The faceplates for a wristwatch manufactured in the examples and comparative examples were observed with the unaided eye from the surface side on which the time characters were provided, and the appearance thereof was evaluated in accordance with the following seven criteria.

A: Has an exceptionally excellent appearance rich with stereoscopic effect.

B: Has a very excellent appearance rich with stereoscopic effect.

C: Has an excellent appearance with stereoscopic effect.

D: Has a good appearance with stereoscopic effect.

E: Has a slightly poor appearance with inadequate stereoscopic effect.

F: Has a poor appearance with inferior stereoscopic effect.

G: Has a very poor appearance with inferior stereoscopic effect.

### 3. Evaluation of the Optical Transmission Properties of the Faceplate for a Wristwatch

The faceplates for a wristwatch manufactured in the example and comparative examples were evaluated for optical transmission properties using a method such as the following. First, solar batteries and the faceplates for a wristwatch were placed in a darkroom. Light from a white fluorescent light (light source) set at a predetermined distance away was made incident on the light receiving surface of unconnected solar batteries. A [mA] is the electric current generated by the solar batteries in this case. Next, light from a white fluorescent light (light source) set at the same predetermined distance away as above was made incident on the upper surface of the light receiving surfaces of the solar batteries in a state in which the faceplates for a wristwatch were superimposed. B [mA] is the electric current generated by the solar batteries in this state. The optical transmission properties of the faceplates for a timepiece was calculated using the expression (B/A)×100, and an evaluation was made in accordance with the following five criteria. It is apparent that better optical transmission properties correspond to better optical transmission properties of the faceplates for a timepiece. The faceplates for a timepiece of the examples and comparative examples were superimposed on the solar battery so that the surface provided with the time characters faced the white fluorescent light (light source).

A: 40% or more

B: 32% or more, and less than 40%

C: 25% or more, and less than 32%

D: 17% or more, and less than 25%

E: less than 17%

### 4. Evaluation of Radio Wave Transmissivity

The faceplates for a timepiece manufactured in the examples and comparative examples were evaluated for radio wave transmissivity using a method such as the following. Prepared first were timepiece cases and internal modules (movements) for a wristwatch provided with a radio-wave-receiving antenna.

Next, the internal modules (movements) for a wristwatch and the faceplates for a wristwatch were incorporated into the timepiece cases, and the radio wave-receiving sensitivity was measured in this state. The faceplates for a timepiece of the examples and comparative examples were configured at this time so that the surface provided with the time characters faced the external surface side. The reduction in sensitivity (dB) when the faceplates for a wristwatch were incorporated was evaluated in accordance with the following four criteria using as a reference the receiving sensitivity of when the faceplates for a wristwatch had not been incorporated. It is apparent a lower reduction in the radio wave-receiving sensitivity corresponds to a better radio wave transmissivity in the faceplates for a wristwatch.

A: Reduction in sensitivity not observed (equal to or less than the detection limit)

B: Reduction in sensitivity observed at less than 0.7 dB.

C: Reduction in sensitivity at 0.7 dB or more and less than 1.0 dB.

D: Reduction in sensitivity at 1.0 dB or more.

These results are shown in Table 2.

TABLE 2

| | | Optical | | |
|---|---|---|---|---|
| | | transmission | Radio wave | Color tone |
| | Appearance | properties | transmissivity | stability |
| Example 1 | A | A | A | A |
| Example 2 | A | A | A | A |
| Example 3 | A | A | A | A |
| Example 4 | A | A | A | A |
| Example 5 | A | A | A | A |
| Example 6 | A | A | A | A |
| Example 7 | D | A | A | A |
| Example 8 | B | A | A | A |
| Example 9 | B | A | A | A |
| Example 10 | C | A | A | A |
| Example 11 | C | A | A | A |
| Example 12 | C | A | A | A |
| Example 13 | D | A | A | A |
| Comparative | G | A | A | A |
| example 1 | | | | |
| Comparative | G | A | A | A |
| example 2 | | | | |
| Comparative | F | A | A | A |
| example 3 | | | | |
| Comparative | E | A | A | A |
| example 4 | | | | |
| Comparative | E | A | A | A |
| example 5 | | | | |

It is apparent from Table 2 that all of the faceplates for a timepiece of the invention have rich stereoscopic effect and excellent aesthetic appearance. The faceplates for a timepiece of the invention also have excellent optical transmission properties and radio wave transmissivity. In contrast, satisfactory results could not be obtained in the comparative examples.

Timepieces such as that shown in FIG. 4 were assembled using the faceplates for a timepiece obtained in the examples and comparative examples. The timepieces obtained in this manner were tested and evaluated in the same manner as described above, and the same results as those described above were obtained.

What is claimed is:

1. A timepiece faceplate, comprising:
a microlens layer in which a plurality of microlenses are arranged in an orderly fashion as viewed from above; and
a decorative layer provided with a repeating design having the same arrangement as the microlenses and a pitch that differs from that of the microlenses, wherein
the microlens layer and the decorative layer are superimposed when viewed from above.

2. The timepiece faceplate according to claim 1, wherein
in a case that centers of microlenses that are adjacent when the timepiece faceplate is viewed from above are connected by a straight line, a plurality of triangles are arranged in an orderly fashion in accordance with the straight line.

3. The timepiece faceplate according to claim 2, wherein
the triangles are equilateral triangles.

4. The timepiece faceplate according to claim 1, wherein
in a case that the centers of microlenses that are adjacent when the timepiece faceplate is viewed from above are connected by a straight line, a plurality of quadrangles are arranged in an orderly fashion in accordance with the straight line.

5. The timepiece faceplate according to claim 4, wherein
the quadrangles are squares.

6. The timepiece faceplate according to claim 1, wherein
the distance from a lens surface of the microlenses to a surface of the decorative layer is 100 μm or more and 1000 μm or less.

7. The timepiece faceplate according to claim 1, wherein
the focal distance of the microlenses is 100 μm or more and 1000 μm or less.

8. The timepiece faceplate according to claim 1, wherein
the pitch of the microlenses is 50 μm or more and 500 μm or less.

9. The timepiece faceplate according to any of claim 1, wherein
the pitch of constituent units of the repeating design is 40 μm or more and 550 μm or less.

10. The timepiece faceplate according to claim 1, wherein
the relationship 0.5≦L₁/L₀≦1.5 is satisfied, where L₀ [μm] is the focal distance of the microlenses, and L₁ [μm] is the distance from the lens surface of the microlenses to the surface of the decorative layer.

11. The timepiece faceplate according to claim 1, wherein
the relationship 0.5≦P_{R}/P_{ML}≦1.5 is satisfied, where P_{ML} [μm] is the pitch of the microlenses, and P_{R} [μm] is the pitch of the constituent units of the repeating design.

12. The timepiece faceplate according to claim 1, wherein
when the timepiece faceplate is viewed from above, the repeating design of the decorative layer and the microlenses of the microlens layer are provided to at least one part of a portion where time characters are not provided; and the repeating design of the decorative layer and/or the microlenses of the microlens layer are not provided to a portion in which the time characters are provided.

13. A timepiece comprising the timepiece faceplate according to claim 1.
